(19) United States
(12) Patent Application Publication
(10) Pub. No.: US 2025/0293485 A1
(43) Pub. Date: Sep. 18, 2025

(54) FUSE HOLDER

(71) Applicant: Suzhou Littelfuse OVS Co., Ltd., Suzhou (CN)

(72) Inventors: Shangchun Pan, Suzhou (CN); Du Cheng, Suzhou (CN)

(73) Assignee: Suzhou Littelfuse OVS Co., Ltd., Suzhou, JS (CN)

(21) Appl. No.: 19/076,369

(22) Filed: Mar. 11, 2025

(30) Foreign Application Priority Data
Mar. 15, 2024 (CN) 202410298627.3

(51) Int. Cl. H02B 1/04; H02B 1/20

(52) U.S. Cl. CPC H02B 1/04; H02B 1/20

(57) ABSTRACT

A fuse holder is provided to protect a fuse device by preventing a fuse body of the fuse device from shaking when the fuse device is vibrating. The fuse holder can include a planar portion with an aperture for receiving a securing mechanism therein a first extension portion disposed adjacent to and extending from a first end of the planar portion at an angle relative to the planar portion, a first end of the first extension portion spanning a length of the first end of the planar portion, and a first annular portion disposed adjacent to and extending from a second end of the first extension portion, the first annular portion having a partially circumferential shape for receiving a cylindrically-shaped fuse body therein, and the second end of the first extension portion being adjacent to the first end of the first extension portion.

### CROSS-REFERENCE TO CORRESPONDING APPLICATIONS

This application claims the benefit of priority to, Chinese Patent Application No. 2024102986273, filed Mar. 15, 2024, entitled “FUSE HOLDER,” which application is incorporated herein by reference in its entirety.

### FIELD

The present disclosure generally relates to fuse devices. More particularly, the present disclosure relates to a fuse holder for a fuse device.

### BACKGROUND

Fuse devices are well known in the art, and known systems and methods for securing and supporting a fuse device include suspending a fuse body between terminals that are fixed with securing mechanisms, such as bolts. As such, the fuse body is suspended without any direct support thereto or thereon, directly contacting only the terminals.

For example FIG. 1A, FIG. 1B, and FIG. 1C illustrate a fuse device system 100 known in the art. As seen, a fuse body 102 is suspended between a terminal 104 and a terminal 106. A securing mechanism 108 fixes the terminal 104 to a busbar 112, and a securing mechanism 110 fixes the terminal 106 to a busbar 114, but neither the securing mechanism 108 nor the securing mechanism 110 provides any support to the fuse body 102.

When the fuse device is vibrating, such as during a vibration test or during use, the fuse body shakes violently without anything to minimize movement thereof. As such, points of the terminal 104 and the terminal 106 labeled in FIG. 1A as a high stress area are, in fact, subject to high stress and prone to breakage, cracking, and/or damage thereto.

In view of the above, there is a continuing, ongoing need for improved systems and methods for securing and supporting fuse devices.

### BRIEF SUMMARY

This Brief Summary is provided to introduce a selection of concepts in a simplified form that are further described below in the Detailed Description. This Brief Summary is not intended to identify key features or essential features of claimed subject matter or intended as an aid in determining scope of the claimed subject matter.

In some embodiments, a fuse holder can include a planar portion with an aperture for receiving a securing mechanism therein, a first extension portion disposed adjacent to and extending from a first end of the planar portion at an angle relative to the planar portion, a first end of the first extension portion spanning a length of the first end of the planar portion, and a first annular portion disposed adjacent to and extending from a second end of the first extension portion, the first annular portion having a partially circumferential shape for receiving a cylindrically-shaped fuse body therein, wherein the second end of the first extension portion can be adjacent to the first end of the first extension portion.

In some embodiments, the angle between the planar portion and the first extension portion can be greater than 0 and less than 90°.

In some embodiments, the angle between the planar portion and the first end of the first extension portion can be constant, and the angle between the planar portion and the second end of the first extension portion can progressively increase or decrease to match the partially circumferential shape of the first annular portion.

In some embodiments, a center of origin for the partially circumferential shape of the first annular portion can be outside of the planar portion.

In some embodiments, the fuse holder can include a support structure between at least part of the first end of the planar portion and at least part of the first end of the first extension portion.

In some embodiments, at least part of the first end of the planar portion and at least part of the first end of the first extension portion can be partially raised or partially depressed to form the support structure.

In some embodiments, the first annular portion can be shaped for circumscribing and holding a majority of half of a circumference of the cylindrically-shaped fuse body.

In some embodiments, the fuse holder can include a second extension portion disposed adjacent to and extending from a second end of the planar portion at an angle relative to the planar portion, a first end of the second extension portion spanning a length of the second end of the planar portion, and a second annular portion disposed adjacent to and extending from a second end of the second extension portion, the second annular portion having the partially circumferential shape for receiving the cylindrically-shaped fuse body therein, wherein the second end of the second extension portion can be adjacent to the first end of the second extension portion, and wherein the second end of the planar portion can be parallel to the first end of the planar portion.

In some embodiments, the first annular portion can be shaped for circumscribing and holding a majority of a first half of a circumference of the cylindrically-shaped fuse body, and the second annular portion can be shaped for circumscribing and holding a majority of a second half of the circumference of the cylindrically-shaped fuse body.

In some embodiments, an open end of the first annular portion can be offset from an open end of the second annular portion by approximately 180° on the circumference of the cylindrically-shaped fuse body.

In some embodiments, an electrical circuit can includes a fuse device, the fuse device including a cylindrically-shaped fuse body disposed between a first terminal and a second terminal, a first fuse holder secured to the first terminal with a first securing mechanism and circumscribing and holding a majority of at least half of a circumference of the cylindrically-shaped fuse body at a first end of the cylindrically-shaped fuse body, and a second fuse holder secured to the second terminal with a second securing mechanism and circumscribing and holding a majority of at least half of the circumference of the cylindrically-shaped fuse body at a second end of the cylindrically-shaped fuse body, wherein each of the first fuse holder and the second fuse holder can include a planar portion with an aperture for receiving the first securing mechanism or the second securing mechanism therein, a first extension portion disposed adjacent to and extending from a first end of the planar portion at an angle relative to the planar portion, a first end of the first extension portion spanning a length of the first end of the planar portion, and a first annular portion disposed adjacent to and extending from a second end of the first extension portion, the first annular portion having a partially circumferential shape for receiving the cylindrically-shaped fuse body therein, wherein the second end of the first extension portion can be adjacent to the first end of the first extension portion.

In some embodiments, the planar portion of the first fuse holder can rest on top of the first terminal, which can rest on top of a first busbar, and the planar portion of the second fuse holder can rest on top of the second terminal, which can rest on top of a second busbar.

In some embodiments, the aperture of the planar portion of the first fuse holder can align with apertures of the first terminal and the first busbar for receiving the first securing mechanism therein, and the aperture of the planar portion of the second fuse holder can align with apertures of the second terminal and the second busbar for receiving the second securing mechanism therein.

In some embodiments, current can flow from the first busbar to the first terminal through the cylindrically-shaped fuse body to the second terminal to the second busbar without flowing through or interruption by the first fuse holder or the second fuse holder.

In some embodiments, an open end of the first annular portion of the first fuse holder can be offset from an open end of the first annular portion of the second fuse holder by approximately 180° on the circumference of the cylindrically-shaped fuse body.

In some embodiments, each of the first fuse holder and the second fuse holder can include a second extension portion disposed adjacent to and extending from a second end of the planar portion at an angle relative to the planar portion, a first end of the second extension portion spanning a length of the second end of the planar portion, and a second annular portion disposed adjacent to and extending from a second end of the second extension portion, the second annular portion having the partially circumferential shape for receiving the cylindrically-shaped fuse body therein, wherein the second end of the second extension portion can be adjacent to the first end of the second extension portion, and wherein the second end of the planar portion can be parallel to the first end of the planar portion.

In some embodiments, the first annular portion of the first fuse holder can circumscribe and hold a majority of a first half of the circumference of the cylindrically-shaped fuse body at the first end thereof, the second annular portion of the first fuse holder can circumscribe and hold a majority of a second half of the circumference of the cylindrically-shaped fuse body at the first end thereof, the first annular portion of the second fuse holder can circumscribe and hold a majority of the first half of the circumference of the cylindrically-shaped fuse body at the second end thereof, and the second annular portion of the second fuse holder can circumscribe and hold a majority of the second half of the circumference of the cylindrically-shaped fuse body at the second end thereof.

In some embodiments, a power distribution circuit can include the electrical circuit with the fuse device, the first fuse holder, and the second fuse holder.

In some embodiments, a power distribution unit can include an electrical circuit that can includes a fuse device and a fuse holder, wherein a fuse body of the fuse device can be mechanically secured in place via a first part of the fuse holder holding the fuse body, wherein an electrical terminal of the fuse device can be mechanically secured in place via apertures of a second part of the fuse holder, the electrical terminal, and a busbar receiving a securing mechanism therein, and wherein current can flow from the busbar through the fuse device without flowing through or interruption by the fuse holder.

In some embodiments, the fuse holder can hold the fuse body at a first end of the fuse body and at a second end of the fuse body.

Other technical features may be readily apparent to one skilled in the art from the following figures, descriptions, and claims.

### BRIEF DESCRIPTION OF THE SEVERAL VIEWS OF THE DRAWINGS

FIG. 1A is a side view illustrating a fuse device system known in the art.

FIG. 1B is a side view illustrating a fuse device system known in the art.

FIG. 1C is a top view illustrating a fuse device system known in the art.

FIG. 2A is a perspective view illustrating a fuse device system in accordance with disclosed embodiments.

FIG. 2B is a top view illustrating a fuse device system in accordance with disclosed embodiments.

FIG. 2C is a side view illustrating a fuse device system in accordance with disclosed embodiments.

FIG. 3A is a perspective view illustrating a fuse holder in accordance with disclosed embodiments.

FIG. 3B is a side view illustrating a fuse holder in accordance with disclosed embodiments.

FIG. 3C is a perspective view illustrating a fuse holder in operation in accordance with disclosed embodiments.

FIG. 3D is a side view illustrating a fuse holder in operation in accordance with disclosed embodiments.

FIG. 3E is an exploded view illustrating a fuse holder in operation in accordance with disclosed embodiments.

FIG. 4A is a perspective view illustrating a fuse holder in accordance with disclosed embodiments.

FIG. 4B is a side view illustrating a fuse holder in accordance with disclosed embodiments.

FIG. 4C is a perspective view illustrating a fuse holder in operation in accordance with disclosed embodiments.

FIG. 4D is a perspective view illustrating a fuse holder in operation in accordance with disclosed embodiments.

FIG. 4E is an exploded view illustrating a fuse holder in operation in accordance with disclosed embodiments.

FIG. 5A is a side view illustrating current flow in a fuse device system in accordance with disclosed embodiments.

FIG. 5B is side view illustrating current flow in a fuse device system in accordance with disclosed embodiments.

FIG. 6 is a schematic view illustrating electrical circuits in a power distribution unit in accordance with disclosed embodiments.

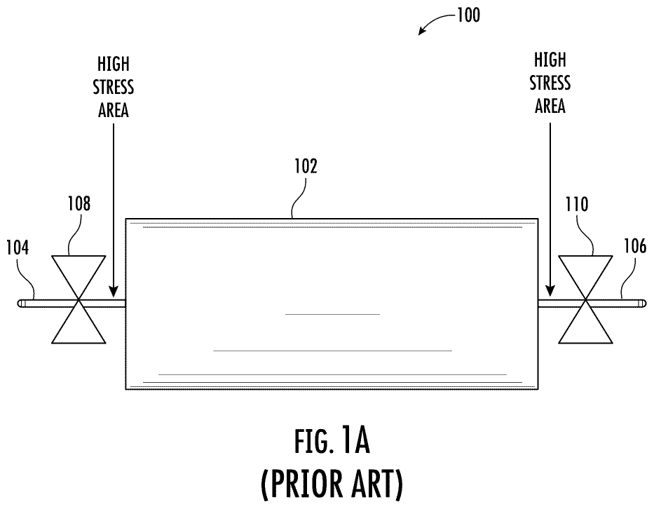

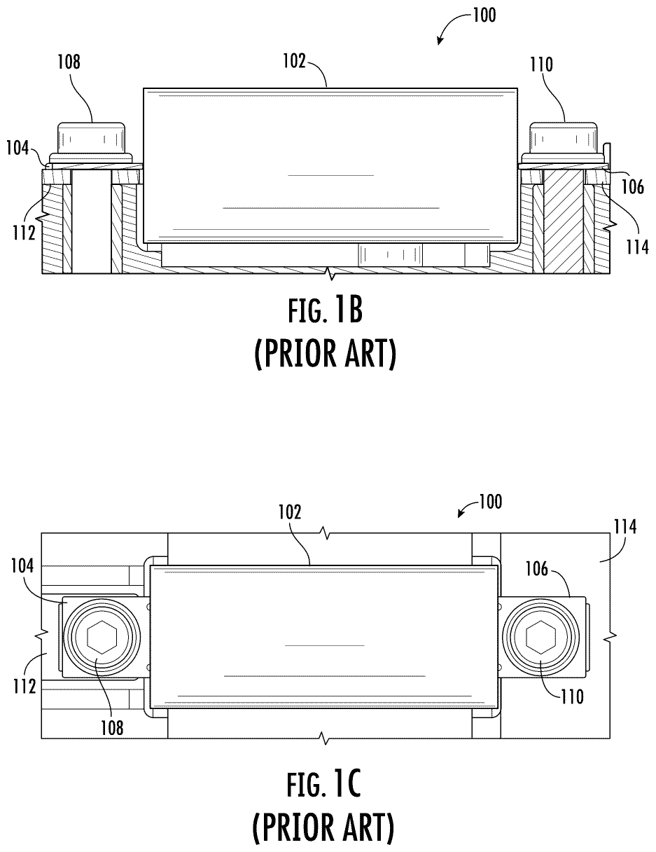

### DETAILED DESCRIPTION

Exemplary embodiments of a fuse holder in accordance with the present disclosure will now be described more fully hereinafter with reference made to the accompanying drawings. The fuse holder may, however, be embodied in many different forms and should not be construed as being limited to the embodiments set forth herein. Rather, these embodiments are provided so that this disclosure will convey certain exemplary aspects of the fuse holder to those skilled in the art.

In accordance with disclosed embodiments, a fuse holder can be secured to a terminal of a fuse device while also supporting and holding a fuse body of the fuse device. In this manner, the fuse holder can protect the fuse device by preventing and/or minimizing the fuse body from shaking when the fuse device is vibrating, thereby avoiding vibration issues associated with fuse devices known in the art. Advantageously, the fuse holder can provide mechanical support to the fuse device, including the fuse body, without interruption of or impact on current flow through the fuse device and without impacting any electrical connections of the fuse device.

The fuse holder disclosed herein can be used in connection with any fuse device as would be understood by one of ordinary skill in the art, including a fuse device with any weight. However, because fuse devices with heavy weights are known to suffer the most damage when vibrating, the fuse holder disclosed herein can be used, in particular, with heavy fuse devices, such as fuse devices weighing 90-380 g, fuse devices weighing up to 2000 g, or fuse devices weighing more than 2000 g. However, embodiments disclosed herein are not limited by these weights. In particular, the fuse holder disclosed herein can be designed with the strength needed to hold a fuse device of any weight in the manner disclosed herein.

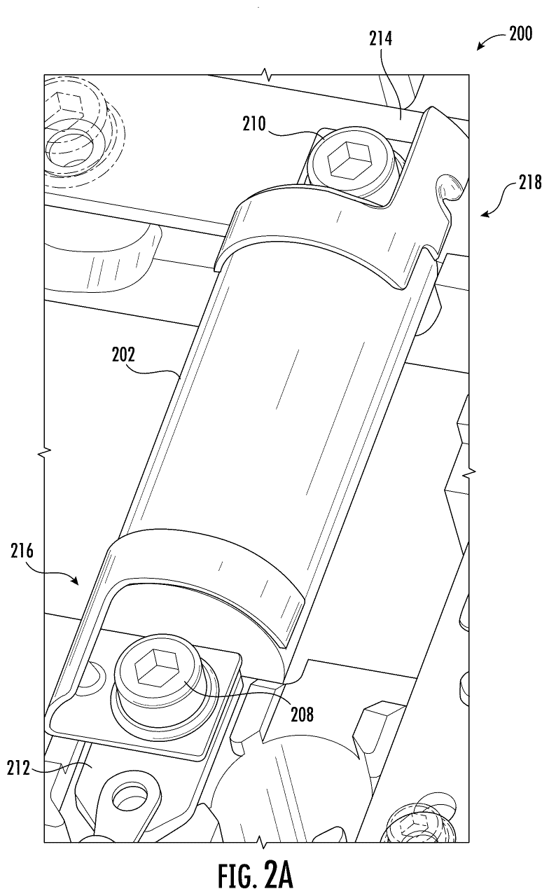

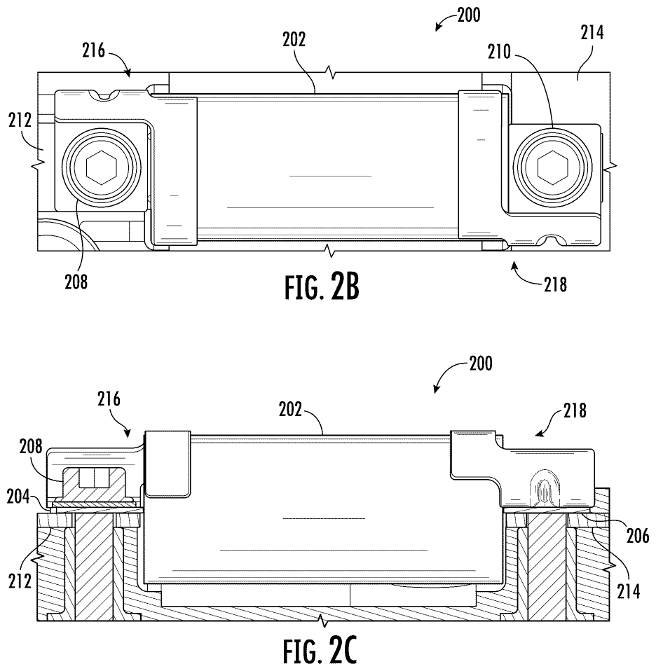

FIG. 2A, FIG. 2B, and FIG. 2C illustrate a fuse device system 200 in accordance with disclosed embodiments. As seen, the fuse device system 200 can include a fuse holder 216 fixing a terminal 204 to a busbar 212 and holding a first end of a fuse body 202 and a fuse holder 218 fixing a terminal 206 to a busbar 214 and holding a second end of the fuse body 202.

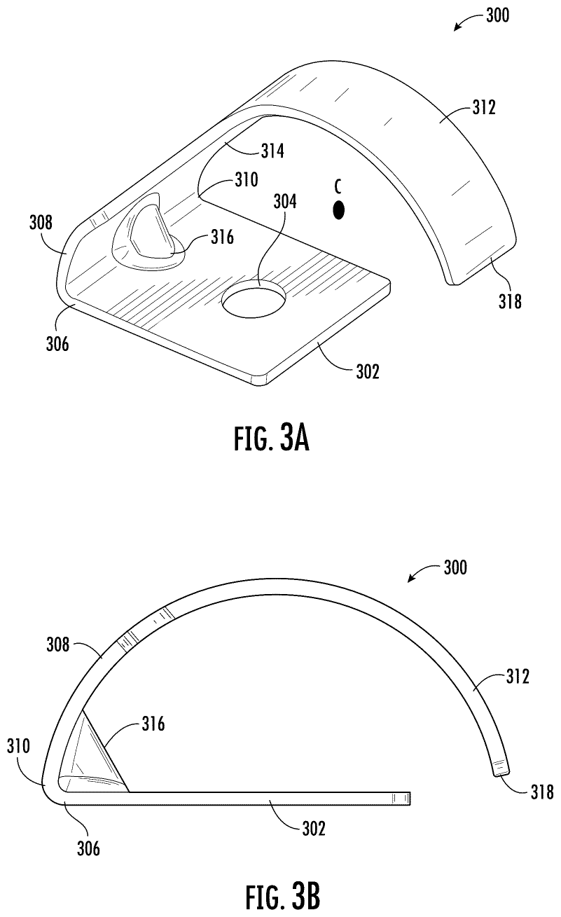

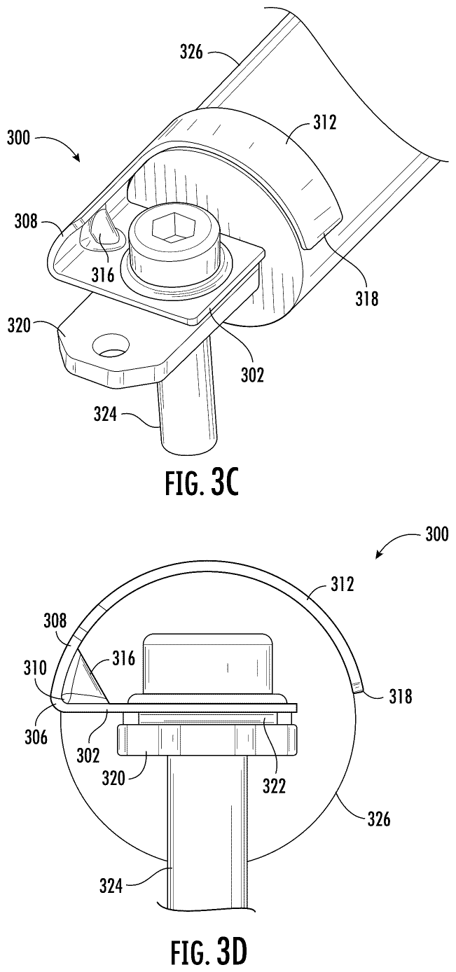

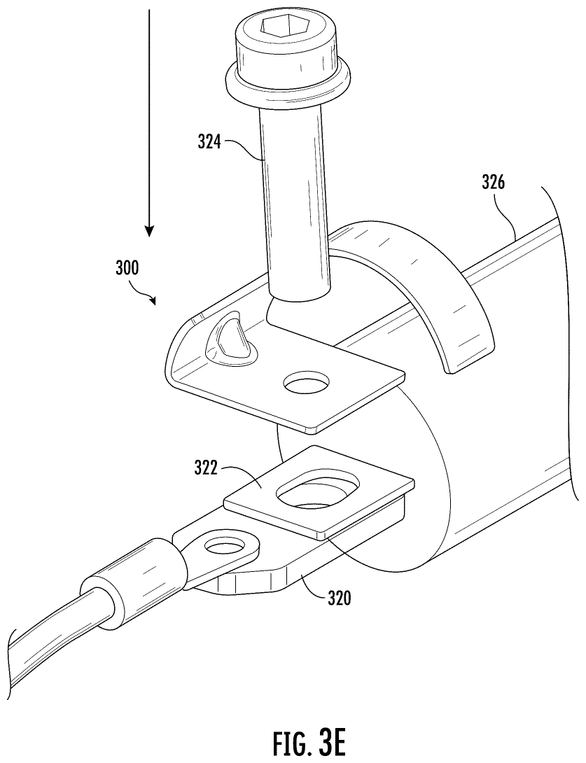

FIG. 3A and FIG. 3B illustrate a fuse holder 300 in accordance with one embodiment disclosed herein. However, it is to be understood that that fuse holder 300 can be the same or similar to the fuse holder 216 and/or the fuse holder 218.

As seen, the fuse holder 300 can include a planar portion 302, an extension portion 308, and an annular portion 312. In some embodiments, the planar portion 302, the extension portion 308, and the annular portion 312 can include one contiguous piece of material shaped to form the fuse holder 300. For example, the planar portion 302, the extension portion 308, and the annular portion 312 can be stamped or injection molded to form the fuse holder 300. In some embodiments, the fuse holder 300 can include stainless steel or a copper alloy. However, embodiments disclosed are not so limited and could be made from any material as would be known and desired by one of ordinary still in the art.

The planar portion 302 can be flat like a washer and be any shape as would be known and desired by one of ordinary skill in the art. For example, although the planar portion 302 is shown as rectangular or square in FIG. 3A and FIG. 3B, embodiments disclosed are not so limited. Instead, the planar portion 302 can be rectangular, square, circular, oval, triangular, hexagonal, and the like. In any embodiment, the planar portion 302 can include an aperture 304 for receiving a securing mechanism therein.

The extension portion 308 can be disposed adjacent to and extending from a first end 306 of the planar portion 302 at an angle relative to the planar portion 302. In some embodiments, a first end 310 of the extension portion 308 can span a length of the first end 306 of the planar portion 302. However, in some embodiments, the first end 310 of the extension portion 308 can span part of the length of the first end 306 of the planar portion 302. In some embodiments, the angle between the planar portion 302 and the extension portion 308 can be greater than 0 and less than 90°. Additionally or alternatively, the angle between the planar portion 302 and the first end 310 of the extension portion 308 can be constant, but the angle between the planar portion 302 and a second end 314 of the extension portion 308 can progressively increase or decrease to match a partially circumferential shape of the annular portion 312.

In this regard, the annular portion 312 can be disposed adjacent to and extending from the second end 314 of the extension portion 308 such that the second end 314 of the extension portion 308 can be adjacent to the first end 310 of the extension portion 308. As such, a center of origin C for the partially circumferential shape of the annular portion 312 can be outside of the planar portion 302. That is, in some embodiments, the annular portion 312 does not overhang the planar portion 302. The partially circumferential shape of the annular portion 312 can be shaped for receiving a cylindrically-shaped fuse body therein, and in some embodiments, the annular portion 312 can be shaped for circumscribing and holding a majority of half of a circumference of the cylindrically-shaped fuse body.

Although the annular portion 312 is shown with a round shape in the figures, it is to be understood that embodiments disclosed herein are not so limited and that the annular portion 312 could have any shape as would be known and desired by one of ordinary skill in the art. For example, the annular portion 312 could be rectangular or any other shape that enables circumscribing and holding a fuse body. Indeed, if the fuse body has a square shape, then the annular portion 312 can have a corresponding square shape for circumscribing and holding at least part of an exterior of the fuse body.

In some embodiments, the fuse holder 300 can also include a support structure 316 between at least part of the first end 306 of the planar portion 302 and at least part of the first end 310 of the extension portion 308 to provide additional stability and strength to the fuse holder 300. In some embodiments, at least part of the first end 306 of the planar portion 302 and at least part of the first end 310 of the extension portion 308 can be partially raised or partially depressed to form the support structure 316.

In operation and as seen in FIG. 3C, FIG. 3D, and FIG. 3E, the fuse holder 300 can be secured to a terminal 322 via a securing mechanism 324, such as a bolt, and hold a fuse body 326. For example, the fuse body 326 can be cylindrically-shaped, and the fuse holder 300 can hold the majority of at least half of the circumference of the fuse body 326.

In some embodiments, the planar portion 302 of the fuse holder 300 can rest on top of the terminal 322, and the terminal 322 can rest on top of a busbar 320. Additionally or alternatively, in some embodiments, the aperture 304 of the planar portion 302 of the fuse holder 300 can align with apertures of the terminal 322 and the busbar 320 for receiving the securing mechanism 324 therein.

To install the fuse holder 300, the securing mechanism 324 can be removed from the terminal 322 and the busbar 320. Then, as best seen in FIG. 3E, the fuse holder 300 can be placed as illustrated and described, for example, by vertically placing the fuse holder 300 on top of the terminal 322 and the fuse body 326, before securing with the securing mechanism 324 as illustrated and described.

Although only one terminal 322 and one end of the fuse body 326 are shown in FIG. 3C, FIG. 3D, and FIG. 3E, it is to be understood that a fuse holder can be used in connection with both ends of a fuse device as shown in FIG. 2A, FIG. 2B, and FIG. 2C. For example, the fuse body 326 can be disposed between the terminal 322 and a second terminal, the fuse holder 300 can secure and hold the fuse device at a first end thereof as described, and a second fuse holder can secure and hold the fuse device at a second end thereof. For example, the second fuse holder can be secured to the second terminal via a second securing mechanism, such as a bolt, and hold the fuse body 326 at the second end thereof. As above, the second fuse holder can hold the majority of at least half of the circumference of the fuse body 326.

In these embodiments and as best seen in FIG. 2A, FIG. 2B, and FIG. 2C, an open end of the annular portion 312 of the fuse holder 300 can be offset from an open end of the annular portion of the second fuse holder by approximately 180° on the circumference of the cylindrically-shaped fuse body 300.

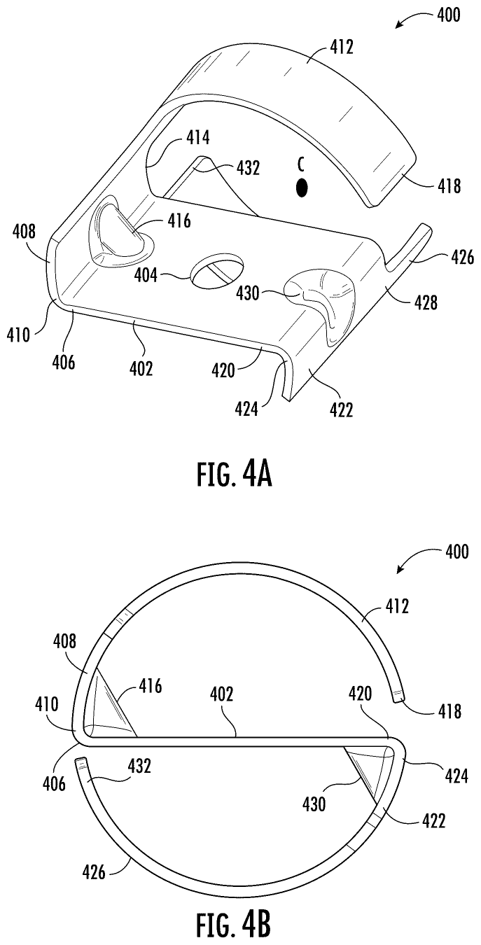

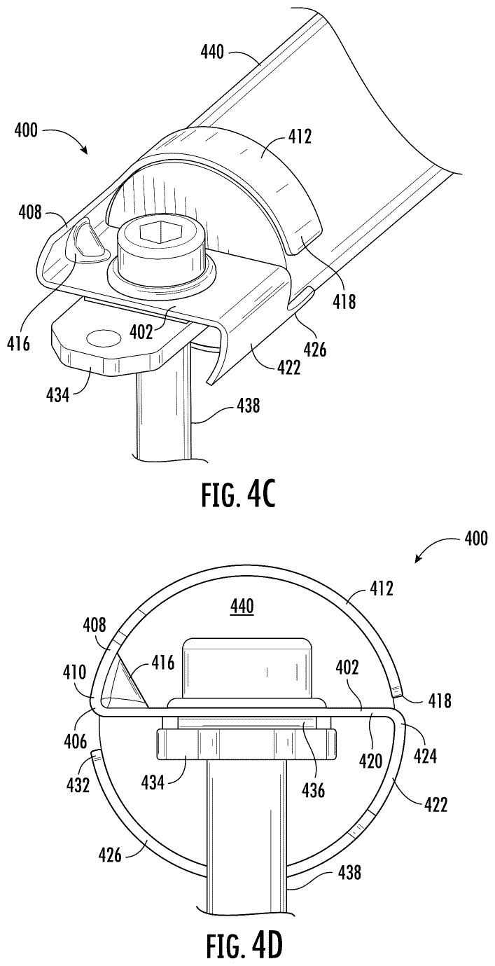

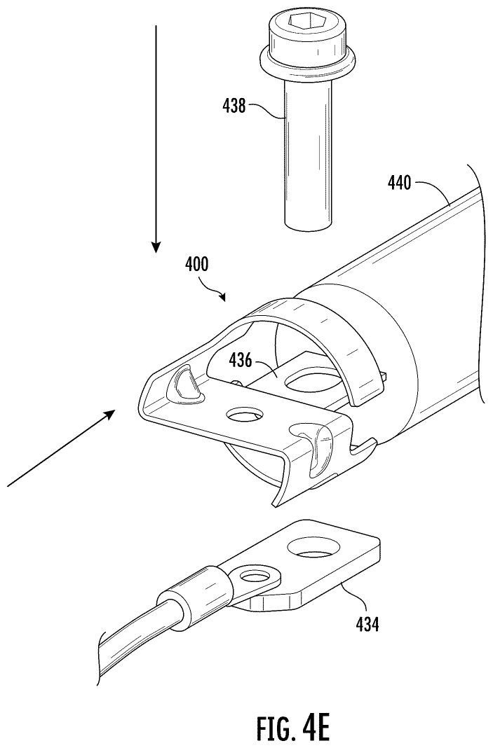

Another embodiment of a fuse holder 400 is illustrated in FIG. 4A and FIG. 4B. As seen, the fuse holder 400 can include a planar portion 402, a first extension portion 408, a first annular portion 412, a second extension portion 422, and a second annular portion 426. In some embodiments, the planar portion 402, the first extension portion 408, the first annular portion 412, the second extension portion 422, and the second annular portion 426 can include one contiguous piece of material shaped to form the fuse holder 400. For example, the planar portion 402, the first extension portion 408, the first annular portion 412, the second extension portion 422, and the second annular portion 426 can be stamped or injection molded to form the fuse holder 400. In some embodiments, the fuse holder 400 can include stainless steel or a copper alloy. However, embodiments disclosed are not so limited and could be made from any material as would be known and desired by one of ordinary still in the art.

The planar portion 402 can be flat like a washer and be any shape as would be known and desired by one of ordinary skill in the art. For example, although the planar portion 402 is shown as rectangular or square in FIG. 4A and FIG. 4B, embodiments disclosed are not so limited. Instead, the planar portion 402 can be rectangular, square, circular, oval, triangular, hexagonal, and the like. In any embodiment, the planar portion 402 can include an aperture 404 for receiving a securing mechanism therein.

The first extension portion 408 can be disposed adjacent to and extending from a first end 406 of the planar portion 402 at an angle relative to the planar portion 402. In some embodiments, a first end 410 of the first extension portion 408 can span a length of the first end 406 of the planar portion 402. However, in some embodiments, the first end 410 of the first extension portion 408 can span part of the length of the first end 406 of the planar portion 402. In some embodiments, the angle between the planar portion 402 and the first extension portion 408 can be greater than 0 and less than 90°. Additionally or alternatively, the angle between the planar portion 402 and the first end 410 of the first extension portion 408 can be constant, but the angle between the planar portion 402 and a second end 414 of the first extension portion 408 can progressively increase or decrease to match a partially circumferential shape of the first annular portion 412.

In this regard, the first annular portion 412 can be disposed adjacent to and extending from the second end 414 of the first extension portion 408 such that the second end 414 of the first extension portion 408 can be adjacent to the first end 410 of the first extension portion 408. As such, a center of origin C for the partially circumferential shape of the first annular portion 412 can be outside of the planar portion 402. The partially circumferential shape of the first annular portion 412 can be shaped for receiving a cylindrically-shaped fuse body therein, and in some embodiments, the first annular portion 412 can be shaped for circumscribing and holding a majority of a first half of a circumference of the cylindrically-shaped fuse body. In some embodiments, the first half of the circumference of the cylindrically-shaped fuse body can include a top half thereof.

Similarly, the second extension portion 422 can be disposed adjacent to and extending from a second end 420 of the planar portion 402 at an angle relative to the planar portion 402 such that the second end 420 of the planar portion can be parallel to the first end 406 of the planar portion 402. In some embodiments, a first end 424 of the second extension portion 422 can span a length of the second end 420 of the planar portion 402. However, in some embodiments, the first end 424 of the second extension portion 422 can span part of the length of the second end 420 of the planar portion 402. In some embodiments, the angle between the planar portion 402 and the second extension portion 422 can be greater than 0 and less than 90°. Additionally or alternatively, the angle between the planar portion 402 and the first end 424 of the second extension portion 422 can be constant, but the angle between the planar portion 402 and a second end 428 of the second extension portion 422 can progressively increase or decrease to match a partially circumferential shape of the second annular portion 426.

In this regard, the second annular portion 426 can be disposed adjacent to and extending from the second end 428 of the second extension portion 422 such that the second end 428 of the second extension portion 422 can be adjacent to the first end 424 of the second extension portion 422. As such, a center of origin C for the partially circumferential shape of the second annular portion 426 can be outside of the planar portion 402, and in some embodiments, the center of origin C for the first annular portion 412 can the same point as the center of origin for the second annular portion 426. The partially circumferential shape of the second annular portion 426 can be shaped for receiving the cylindrically-shaped fuse body therein, and in some embodiments, the second annular portion 426 can be shaped for circumscribing and holding a majority of a second half of the circumference of the cylindrically-shaped fuse body. In some embodiments, the second half of the circumference of the cylindrically-shaped fuse body can include a bottom half thereof. As such, the fuse holder 400 can hold substantially all of the circumference of the cylindrically-shaped fuse body.

In these embodiments, an open end 418 of the first annular portion 412 can be offset from an open end 432 of the second annular portion 426 by approximately 180° on the circumference of the cylindrically-shaped fuse body.

Although the first annular portion 412 and the second annular portion 426 are shown with round shapes in the figures, it is to be understood that embodiments disclosed herein are not so limited and that the first annular portion 412 and the second annular portion 426 could have any shape as would be known and desired by one of ordinary skill in the art. For example, one or both of the first annular portion 412 and the second annular portion 426 could be rectangular or any other shape that enables circumscribing and holding a fuse body. Indeed, if the fuse body has a square shape, then the first annular portion 412 and the second annular portion 426 can have corresponding square shapes for circumscribing and holding at least part of an exterior of the fuse body.

In some embodiments, the fuse holder 400 can also include a support structure 416 between at least part of the first end 406 of the planar portion 402 and at least part of the first end 410 of the first extension portion 408 to provide additional stability and strength to the fuse holder 400. In some embodiments, at least part of the first end 406 of the planar portion 402 and at least part of the first end 410 of the first extension portion 408 can be partially raised or partially depressed to form the support structure 416. Additionally or alternatively, the fuse holder 400 can include a support structure 430 between at least part of the second end 420 of the planar portion 402 and at least part of the first end 424 of the second extension portion 422 to provide additional stability and strength to the fuse holder 400. In some embodiments, at least part of the second end 420 of the planar portion 402 and at least part of the first end 424 of the second extension portion 422 can be partially raised or partially depressed to form the support structure 430.

In operation and as seen in FIG. 4C, FIG. 4D, and FIG. 4E, the fuse holder 400 can be secured to a terminal 436 via a securing mechanism 438, such as a bolt, and hold a fuse body 440. For example, the fuse body 440 can be cylindrically-shaped, and the fuse holder 400 can hold the majority of the circumference of the fuse body 440.

In some embodiments, the planar portion 402 of the fuse holder 400 can rest on top of the terminal 436, and the terminal 436 can rest on top of a busbar 434. Additionally or alternatively, in some embodiments, the aperture 404 of the planar portion 402 of the fuse holder 400 can align with apertures of the terminal 436 and the busbar 434 for receiving the securing mechanism 438 therein.

To install the fuse holder 400, the securing mechanism 438 can be removed from the terminal 436 and the busbar 434, and the terminal 436 can be removed from the busbar 434. Then, as best seen in FIG. 4E, the fuse holder 400 can be placed as illustrated and described, for example, by horizontally sliding the fuse holder 400 over the terminal 436 and the fuse body 440, and the terminal 436 can be placed relative to the busbar 434 before securing with the securing mechanism 438 as illustrated and described.

Although only one terminal 436 and one end of the fuse body 440 are shown in FIG. 4C, FIG. 4D, and FIG. 4E, it is to be understood that a fuse holder can be used in connection with both ends of a fuse device as shown in FIG. 2A, FIG. 2B, and FIG. 2C. For example, the fuse body 440 can be disposed between the terminal 436 and a second terminal, the fuse holder 400 can secure and hold the fuse device at a first end thereof as described, and a second fuse holder can secure and hold the fuse device at a second end thereof. For example, the second fuse holder can be secured to the second terminal via a second securing mechanism, such as a bolt, and hold the fuse body 440 at the second end thereof. As above, the second fuse holder can hold the majority of the circumference of the fuse body 440.

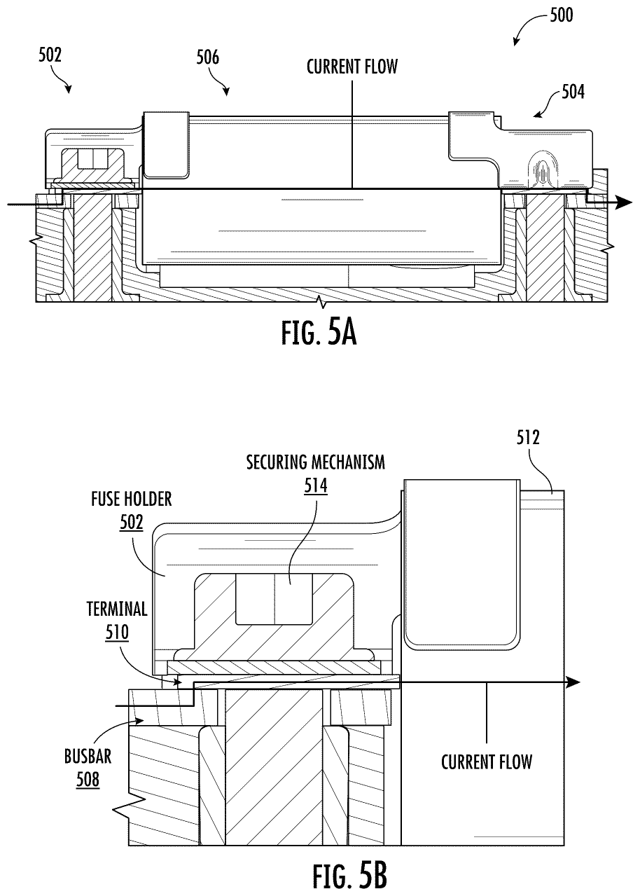

In any embodiment of the fuse holder disclosed herein, current need not flow through the fuse holder, and thus, need not be impacted or interrupted by the fuse holder. For example, FIG. 5A and FIG. 5B illustrate current flow in a fuse device system 500 in accordance with disclosed embodiments. As seen, a first fuse holder 502 can secure and hold a first end of a fuse device 506, and a second fuse fuse fuse holder 504 can hold and secure a second end of the fuse device 506. Current can enter the fuse device 506 by flowing from a first busbar 508 to a first terminal 510 before flowing into a fuse body 512 of the fuse device 506. However, because a design and a shape of the fuse holder 502 facilitate an arrangement of the fuse holder 502 relative to the fuse device 506 as illustrated and described, the current does not flow through the fuse holder 502. Indeed, the current is not impacted or interrupted by the fuse holder 502. Similarly, the current can exit the fuse device 506 by flowing from the fuse body 512 of the fuse device 506 to a second terminal and to a second busbar. However, because a design and a shape of the fuse holder 504 relative to the fuse device 506 facilitate an arrangement of the fuse holder 504 relative to the fuse device 506 as illustrated and described, the current does not flow through the fuse holder 504.

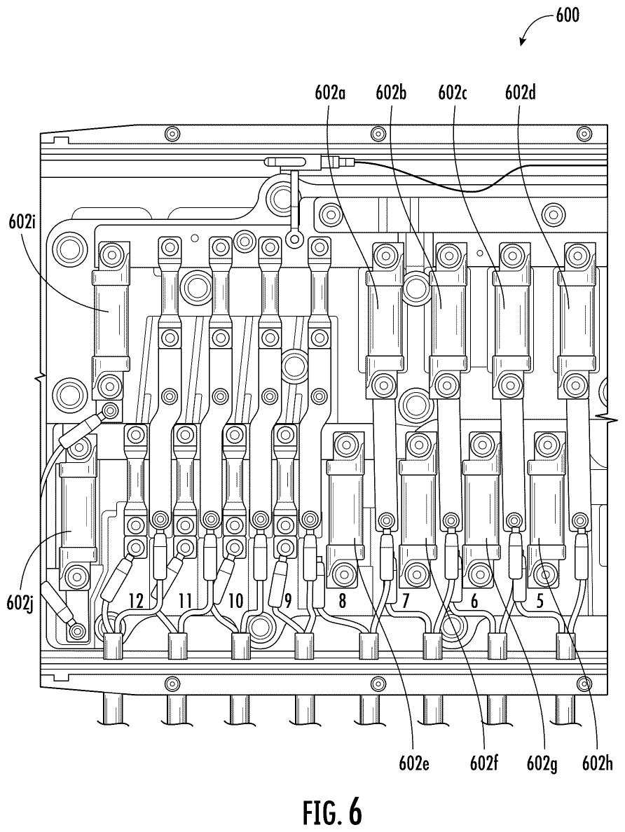

Any embodiment of the fuse holder disclosed herein can be part of an electrical circuit that includes a fuse device. Similarly, any embodiment of the fuse holder disclosed herein can be part of a power distribution circuit that includes electrical circuits. For example, FIG. 6 illustrates electrical circuits in a power distribution unit 600 in accordance with disclosed embodiments. As seen, the power distribution unit 600 can include one or more electrical circuits that include fuse devices 602a, fuse devices 602b, fuse devices 602c, fuse devices 602d, fuse devices 602e, fuse devices 602f, fuse devices 602g, fuse devices 602h, fuse devices 602i, fuse devices 602j—collectively referred to as fuse devices 602. Any or all of the fuse devices 602 can be secured and held by a fuse holder as disclosed herein. For example, a fuse body of any of the fuse devices 602 can be mechanically secured in place via a first part of a fuse holder holding the fuse body, and electrical terminals of any of the fuse devices 602 can be mechanically secured in place via apertures of a second part of the fuse holder, the electrical terminals, and one or more busbars receiving one or more securing mechanisms therein. In some embodiments, the fuse holder can secure and hold any of the fuse devices 602 at one end thereof, and in some embodiments, the fuse holder can secure and hold any of the fuse devices 602 at first and second ends thereof.

As used herein, an element or a step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims and equivalents thereof.

What is claimed is:

1. A fuse holder comprising:
a planar portion with an aperture for receiving a securing mechanism therein;
a first extension portion disposed adjacent to and extending from a first end of the planar portion at an angle relative to the planar portion, a first end of the first extension portion spanning a length of the first end of the planar portion; and
a first annular portion disposed adjacent to and extending from a second end of the first extension portion, the first annular portion having a partially circumferential shape for receiving a cylindrically-shaped fuse body therein,
wherein the second end of the first extension portion is adjacent to the first end of the first extension portion.

2. The fuse holder of claim 1 wherein the angle between the planar portion and the first extension portion is greater than 0 and less than 90°.

3. The fuse holder of claim 1 wherein the angle between the planar portion and the first end of the first extension portion is constant, and wherein the angle between the planar portion and the second end of the first extension portion progressively increases or decreases to match the partially circumferential shape of the first annular portion.

4. The fuse holder of claim 1 wherein a center of origin for the partially circumferential shape of the first annular portion is outside of the planar portion.

5. The fuse holder of claim 1 further comprising:
a support structure between at least part of the first end of the planar portion and at least part of the first end of the first extension portion.

6. The fuse holder of claim 5 wherein at least part of the first end of the planar portion and at least part of the first end of the first extension portion are partially raised or partially depressed to form the support structure.

7. The fuse holder of claim 1 wherein the first annular portion is shaped for circumscribing and holding a majority of half of a circumference of the cylindrically-shaped fuse body.

8. The fuse holder of claim 1 further comprising:
a second extension portion disposed adjacent to and extending from a second end of the planar portion at an angle relative to the planar portion, a first end of the second extension portion spanning a length of the second end of the planar portion; and
a second annular portion disposed adjacent to and extending from a second end of the second extension portion, the second annular portion having the partially circumferential shape for receiving the cylindrically-shaped fuse body therein,
wherein the second end of the second extension portion is adjacent to the first end of the second extension portion, and
wherein the second end of the planar portion is parallel to the first end of the planar portion.

9. The fuse holder of claim 8 wherein the first annular portion is shaped for circumscribing and holding a majority of a first half of a circumference of the cylindrically-shaped fuse body, and wherein the second annular portion is shaped for circumscribing and holding a majority of a second half of the circumference of the cylindrically-shaped fuse body.

10. The fuse holder of claim 8 wherein an open end of the first annular portion is offset from an open end of the second annular portion by approximately 180° on the circumference of the cylindrically-shaped fuse body.

11. An electrical circuit comprising:
a fuse device, the fuse device including a cylindrically-shaped fuse body disposed between a first terminal and a second terminal;
a first fuse holder secured to the first terminal with a first securing mechanism and circumscribing and holding a majority of at least half of a circumference of the cylindrically-shaped fuse body at a first end of the cylindrically-shaped fuse body; and
a second fuse holder secured to the second terminal with a second securing mechanism and circumscribing and holding a majority of at least half of the circumference of the cylindrically-shaped fuse body at a second end of the cylindrically-shaped fuse body,
wherein each of the first fuse holder and the second fuse holder comprise:
a planar portion with an aperture for receiving the first securing mechanism or the second securing mechanism therein;
a first extension portion disposed adjacent to and extending from a first end of the planar portion at an angle relative to the planar portion, a first end of the first extension portion spanning a length of the first end of the planar portion; and
a first annular portion disposed adjacent to and extending from a second end of the first extension portion, the first annular portion having a partially circumferential shape for receiving the cylindrically-shaped fuse body therein,
wherein the second end of the first extension portion is adjacent to the first end of the first extension portion.

12. The electrical circuit of claim 11 wherein the planar portion of the first fuse holder rests on top of the first terminal, which rests on top of a first busbar, and wherein the planar portion of the second fuse holder rests on top of the second terminal, which rests on top of a second busbar.

13. The electrical circuit of claim 12 wherein the aperture of the planar portion of the first fuse holder aligns with apertures of the first terminal and the first busbar for receiving the first securing mechanism therein, and wherein the aperture of the planar portion of the second fuse holder aligns with apertures of the second terminal and the second busbar for receiving the second securing mechanism therein.

14. The electrical circuit of claim 12 wherein current flows from the first busbar to the first terminal through the cylindrically-shaped fuse body to the second terminal to the second busbar without flowing through or interruption by the first fuse holder or the second fuse holder.

15. The electrical circuit of claim 11 wherein an open end of the first annular portion of the first fuse holder is offset from an open end of the first annular portion of the second fuse holder by approximately 180° on the circumference of the cylindrically-shaped fuse body.

16. The electrical circuit of claim 11 wherein each of the first fuse holder and the second fuse holder comprise:
a second extension portion disposed adjacent to and extending from a second end of the planar portion at an angle relative to the planar portion, a first end of the second extension portion spanning a length of the second end of the planar portion; and
a second annular portion disposed adjacent to and extending from a second end of the second extension portion, the second annular portion having the partially circumferential shape for receiving the cylindrically-shaped fuse body therein,
wherein the second end of the second extension portion is adjacent to the first end of the second extension portion, and
wherein the second end of the planar portion is parallel to the first end of the planar portion.

17. The electrical circuit of claim 16 wherein the first annular portion of the first fuse holder circumscribes and holds a majority of a first half of the circumference of the cylindrically-shaped fuse body at the first end thereof, wherein the second annular portion of the first fuse holder circumscribes and holds a majority of a second half of the circumference of the cylindrically-shaped fuse body at the first end thereof, wherein the first annular portion of the second fuse holder circumscribes and holds a majority of the first half of the circumference of the cylindrically-shaped fuse body at the second end thereof, and wherein the second annular portion of the second fuse holder circumscribes and holds a majority of the second half of the circumference of the cylindrically-shaped fuse body at the second end thereof.

18. A power distribution circuit comprising the electrical circuit of claim 11.

19. A power distribution unit comprising:
an electrical circuit that includes a fuse device; and
a fuse holder,
wherein a fuse body of the fuse device is mechanically secured in place via a first part of the fuse holder holding the fuse body,
wherein an electrical terminal of the fuse device is mechanically secured in place via apertures of a second part of the fuse holder, the electrical terminal, and a busbar receiving a securing mechanism therein, and
wherein current flows from the busbar through the fuse device without flowing through or interruption by the fuse holder.

20. The power distribution unit of claim 19 wherein the fuse holder holds the fuse body at a first end of the fuse body and at a second end of the fuse body.
